(19) United States
(12) Patent Application Publication
(10) Pub. No.: US 2014/0021368 A1
(43) Pub. Date: Jan. 23, 2014

(54) Quantum Dot Luminescent Materials

(71) Applicants: Krishnan Chakravarthy, Williamsville, NY (US); Siddhartha Venkata Kamisetti, East Amherst, NY (US); Himanshu Subhash Amin, Solon, OH (US)

(72) Inventors: Krishnan Chakravarthy, Williamsville, NY (US); Siddhartha Venkata Kamisetti, East Amherst, NY (US); Himanshu Subhash Amin, Solon, OH (US)

(73) Assignee: NANOAXIS, LLC, Clarence, NY (US)

(21) Appl. No.: 13/726,026

(22) Filed: Dec. 22, 2012

Related U.S. Application Data
(63) Continuation of application No. 13/555,130, filed on Jul. 21, 2012, now abandoned.

(51) Int. Cl. C03C 4/12; C03C 14/00; F21V 9/16

(52) U.S. Cl. CPC C03C 4/12; F21V 9/16; C03C 14/004; B82Y 20/00
USPC 250/459.1; 428/34.4; 428/426; 252/301.4 R; 252/301.4 F; 252/301.6 S; 252/301.4 S; 252/301.4 P; 977/834

(57) ABSTRACT

A quantum dot dispersed glass article is disclosed herein and associated articles, products, and methods of making thereof. In an aspect, a glass material can incorporate one or more quantum dot dispersed therein, wherein the one or more quantum dot luminesces upon excitation from an excitation source. In another aspect, the quantum dot can take a variety of shapes and sizes. In another aspect, the quantum dot can be water soluble. In yet another aspect, the quantum dot can be dispersed within one or more glass cavities.

### CROSS REFERENCED TO RELATED APPLICATION

This application claims the benefit of U.S. Provisional Patent Application Ser. No. 61/510,403, filed Jul. 21, 2011 and entitled “Quantum Dot Luminescent Materials”, which is incorporated by reference herein in its entirety.

### TECHNICAL FIELD

This disclosure relates to articles of glass that incorporate quantum dots for purposes of exuding various color characteristics including, but not limited to, glass that changes color.

### BACKGROUND

Glass is an article that has a variety of applications and uses such as art, décor, sculptures, kitchen utensils, drinking vessels, table tops, windows, surface materials, bottles, mobile device screens, eye wear, and other such applications. While glass can be transparent, many applications utilize colored glass for various purposes (e.g. artistic, aesthetic, reflection, etc.). Introducing pigments (e.g. iron oxides, manganese oxides, cobalt oxide, lead with antimony, tin compounds, and other such compounds) or introducing minerals into glass can color glass. Such glass maintains a single color such as green, amber, blue, yellow, and so on. With the advancements in material development and technology there is a need for glass that can comprise various new colors and that can exude new color properties wherein an article of glass does not simply have to maintain one static color.

### SUMMARY

The following presents a simplified summary of the disclosure in order to provide a basic understanding of some aspects of the disclosure. This summary is not an extensive overview of the disclosure. It is intended to neither identify key or critical elements of the disclosure nor delineate any scope particular embodiments of the disclosure, or any scope of the claims. Its sole purpose is to present some concepts of the disclosure in a simplified form as a prelude to the more detailed description that is presented later.

In accordance with one or more embodiments and corresponding disclosure, various non-limiting aspects are described in connection with glass articles that exhibit luminescent color characteristics. In accordance with a non-limiting embodiment, in an aspect, an article is provided comprising a glass material incorporating one or more quantum dot dispersed therein, wherein the quantum dot luminesces upon excitation from an excitation source. In an aspect, the quantum dot is of any shape including but not limited to a teardrop, arrow, sphere, tetrapod, rod, or dendrimer. In another aspect, the quantum dot is of any size greater than 1 nm and smaller than 999 nm. In yet another aspect, the quantum dot is water-soluble.

The disclosure further discloses, a quantum dot that is a water-soluble semiconductor comprising: a base semiconductor material; and a shell semiconductor material sourrounding the base material. In an aspect, the base material is a II-IV semiconductor or a III-V semiconductor. In another aspect, the base semiconductor material is a II-IV semiconductor. Also, in an aspect, the base semiconductor material is a III-V semiconductor. In another aspect, the base semiconductor material is at least one of: MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, or HgTe.

Further, the disclosure further discloses, in an aspect, the shell semiconductor material is a II-VI semiconductor or a III-V semiconductor. In an aspect, the shell semiconductor material is a II-VI semiconductor. In another aspect, the shell semiconductor material is a III-V semiconductor. In yet another aspect, the shell semiconductor material is at least one of: MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, or HgTe. In various other aspects, the quantum dot emits at any one or more wavelength in the Ultraviolet, visible, or infrared spectrum. Further, in an aspect, the nanocrystal is any one or more of: dispersed within the glass material, dispersed within a cavity of the glass material, or coated on the surface of the glass material.

The disclosure further discloses a method, comprising dispersing one or more quantum dot into a glass material and exciting the one or more quantum dot using an excitation source. In an aspect, the quantum dot is a water-soluble semiconductor comprising: a base semiconductor material and a shell semiconductor material surrounding the base material.

The following description and the annexed drawings set forth certain illustrative aspects of the disclosure. These aspects are indicative, however, of but a few of the various ways in which the principles of the disclosure may be employed. Other advantages and novel features of the disclosure will become apparent from the following detailed description of the disclosure when considered in conjunction with the drawings.

### BRIEF DESCRIPTION OF THE DRAWINGS

FIG. 1 illustrates an example non-limiting quantum dot dispersed glass material in accordance with one or more implementations.

FIG. 2 illustrates an example non-limiting system for quantum dot dispersion within glass material in accordance with one or more implementations.

FIG. 3 illustrates an example non-limiting glass article with quantum dots dispersed within cavities in accordance with one or more implementations.

FIG. 4 illustrates an example non-limiting system for quantum dot sidpersed within cavities of glass articles in accordance with one or more implementations.

FIG. 5 illustrates an example methodology for making glass material infused with quantum dot dye in accordance with one or more implementations.

FIG. 6 illustrates an example methodology for making glass product with quantum dot dye dispersed therein in accordance with one or more implementations

FIG. 7 illustrates an example methodology for making glass product with quantum dot dye dispersed therein in accordance with one or more implementations.

FIG. 8 illustrates an example nonlimiting glass products coated with quantum dot thin film in accordance with one or more implementations.

FIG. 9 illustrates an example nonlimiting illustration of an excitation source exciting a quantum dot dispersed glass product in accordance with one or more implementations.

### DETAILED DESCRIPTION

### Overview

The innovation is now described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter disclosed in this disclosure relates to glass articles that exhibit luminescent color characteristics. Color is a way to describe an attribute of a glass article and is a significant characteristic of the glass. For instance, glass can be described as colorless (the absence of color), clear (the quality of being transparent or allowing light to pass through), sun colored amethyst (characterized by its purple color and the amount of UV light applied), milk glass (colorless glass that is not clear), olive, amethyst, black, and other such descriptions. Coloring can be accomplished in a variety of ways including utilizing compounds and pigments such as iron oxides, carbon oxides, manganese oxides, cobalt oxide, copper compounds, tin compounds, gold chloride, selenium compounds, antimony oxides, sulfur compounds, uranium oxides, and so on.

Given the advancements in nanotechnology new materials with advanced properties enable the creation of new objects including new glass colors and new methods of coloring glass. Luminescent quantum dots also known as quantum dots are nanometer sized particle with luminescent properties. Quantum dots can vary in many aspects such as sizes (length, width, height, diameter, etc.), aspect ratios, shapes, and formats (e.g. powdered quantum dots, hydrophobic dispersed quantum dots in toluene or other solution, aqueous dispersed quantum dots with or without surface modification, quantum dots with or without associated shelling, quantum dots with or without coatings, and so on). A quantum dot luminesces when excited by an excitation source such as UV light, a light source, an electromagnetic radiation source (e.g. source varying in wavelengths ranging from X-ray to ultraviolet to visible to infrared waves may be used to excite), a particle beam, or other such excitation source).

In general, quantum dots are semiconductors nanoparticles with color characteristics closely related to the size and shape of each individual nanoparticle. In an instance, the smaller the size of the quantum dot (e.g. a smaller diameter for a spherical quantum dot), the higher frequenceies of light are emitted after excitation of the dot, which displays a color shift from red light to blue light emissions. The smallest quantum dots fluoresce in the blue and green colors and the larger quantum dots fluoresce in the red and infrared color spectrum. For example, in the instance of spherical quantum dots comprising a CdSe base material or core (without a shell), the quantum dots can emit at wavelengths such as 610 nm (orange), 580 nm (darker yellow), 577 nm (bright yellow), 571 nm (greenish yellow), 559 nm (lime green), 544 nm (darker green), 514 nm (light blue). By incorporating quantum dots into glass articles they exude color properties of varying intesities and brightness.

### Example Luminescent Glass Materials, Articles, Systems Incorporating Quantum Dots

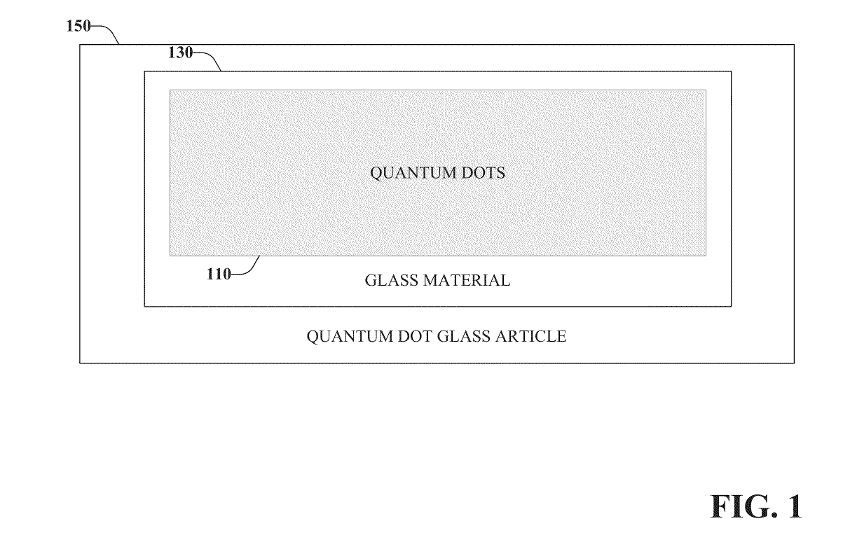

Referring now to the drawings, with reference initially to FIG. 1, shown is a quantum dot 110, glass material 130, and a quantum dot dispersed glass article 150. In an embodiment, shown is an article comprising; a glass material 130 incorporating one or more quantum dot 110 dispersed therein, wherein the one or more quantum dot 110 luminesces upon excitation from an excitation source. A quantum dot 110 is a structured semiconductor nanomaterial, ranging in size from 0.001 nm to 999.99 nm capable of emitting electromagnetic radiation and absorbing energy and emitting electromagnetic radiation, when excited by an excitation source. In an aspect, quantum dot 110 can be of any suitable shape, any suitable size distribution (within the 0.001 nm to 999.99 nm range), any suitable form, and any suitable material composition. Further, glass material 130 is a structured material that can take solid form (wherein the glass is amorphous) or liquid form (sometimes called a glass transition state). Quantum dot dispersed glass article 150 is an article comprising a glass material 130 (e.g. liquid transition glass) wherein one or more quantum dots 110 are dispersed throughout the glass material 130.

In an aspect, the quantum dots 110 are nanoparticles comprised of semiconductor material, sometimes in configuration of a base semiconductor material (sometimes called a core, wherein the core can be of a specific size, such as for example 20 A or 100 Angstroms) surrounded by one or more shell semiconductor material (of varying thickness), that are one or more forms, structures, shapes, material compositions, and sizes. In an embodiment, quantum dot s110 can take form of various shapes. For instance, in an aspect, quantum dots 110 can be at least one of the following shapes; teardrop, arrow, snowflake, multi-leg luminescent nanoparticle, sphere, luminescent tetrapod dot, tetrapod, rod, or dendrimer.

In an aspect, quantum dots 110 can exhibit polytypism or the existence of more than one crystal structure in different domains of the same crystal. The polytypism characteristic can be used to produce branched inorganic nanostructures in a controlled way. In other aspects, polytypic structures can share a common crystal facet, which allows for branching of nanoparticles (e.g. dendrimers, the linking of more than one nanoparticle, branch formation off of an existing nanoparticle, etc.). In another aspect, quantum dots 110 can take the form of arrow-shaped nanocrystal particles. In an instance, arrow-shaped nanocrystal particles can include tree-shaped nanocrystal particles such as pine-tree shaped nanocrystal particles.

In yet another aspect, quantum dots 110 can take the shape of tetrapods, branched tetrapods, monopods (a core with one leg outgrowth), biopods (a core with two leg outgrowths), tripods (a core with three leg outgrowths), rods, arrows, teardrops, disks, cubes, stars, pine-tree shaped, pyramids, branched nanocrystal particles with a core and at least one leg extending from the core, pyramids, or any other suitable structure. Also, in an aspect, the quantum dots 110 can take the shape of non-spherical nanoparticles. In an instance wherein quantum dot 110 a tetrapod quantum dot or a tetrapod shaped quantum dot particle having four leg-like portions formed by the Group 12-15 metal or metalloid and the Group 15-16 element. In an aspect, the four legs are generally disposed about a central region of intersection. The legs are generally, but not strictly, disposed in a tetrahedral configuration about the central region.

In another aspect, quantum dot 110 can be a multi-leg luminescent nanoparticle. A multi-leg luminescent nanoparticle is a particle comprised of a base and one or more legs protruding from the base. In an aspect, a multi-leg luminescent nanoparticle has ‘K’ number of legs extending from a base material wherein “K” is an integer. Each leg is of length “L”, wherein L is a number ranging from 0.001 nm to 999.99 nm and each leg can be a different length L. The multi-leg luminescent nanoparticle has leg widths of width “P”, wherein P is a number ranging from 0.001 nm to 0.999 nm. Each leg width can be of a different width P. Furthermore, in an aspect, the multi-leg luminescent nanoparticle has base lengths which can be adjusted for each unique multi-leg luminescent nanoparticle, the base length can range anywhere from 0.001 nm to 999.999 nm.

In an aspect, a multi-leg luminescent nanoparticle may be constructed with legs of different leg lengths, legs of the same length or a mixture of same length, different leg length, same width, different width, same base length, and or different base length. Each combination of leg length, leg width, base length and or number of legs characterizing each multi-leg luminescent nanoparticle results in numerous different spectral signature outputs for each unique multi-legged luminescent nanoparticle which results in a different tunable color. Thus each multi-leg luminescent nanoparticle can emit energy at different wavelengths in accordance with the customized number of legs, leg lengths, and leg widths of each nanoparticle.

In another aspect, quantum dot 110 can be a multi-branched luminescent nanoparticle compound. A multi-branched luminescent nanoparticle compound is comprised of two or more multi-leg luminescent nanoparticles affixed through bonding, magnetics, and or conjugation. A multi-branched luminescent nanoparticle can either be affixed to or protruding from another multi-branched luminescent nanoparticle. An attached multi-branched luminescent nanoparticle occurs where any leg of a multi-branched luminescent nanoparticle is attached to a base of another multi-leg luminescent nanoparticle through bonding, conjugation or magnetics. In an aspect, bonding can include but is not limited to bonds such as, covalent, ionic, or hydrogen bonding, Van der Waals' forces, or mechanical bonding, and other forms of linking to particles.

In some embodiments, the luminescent quantum dots are characterized by particles having defined sizes. One measure of size is the average leg length of respective nanoparticles (e.g. tetrapods, multi-leg luminescent nanomaterials, etc.). In an instance an leg length ranging from about 5 nm to about 200 nm can occur. In other embodiments, quantum dot 110 can have an leg length of about 7.5 nm, about 10 nm, about 15 nm, about 20 nm, about 25 nm, about 50 nm, about 75 nm, about 100 nm, about 150 nm or about 175 nm. The upper limit of leg length for some particles in the compositions included herein may be about 10 nm, about 20 nm, about 25 nm, about 50 nm, about 75 nm, about 100 nm, about 150 nm, about 175 nm, about 180 nm, about 185 nm about 190, or about 200 nm. Leg lengths may generally be controlled by selection of proportionate amounts of starting materials. Another measure of the size of the particles is the width of the legs. Generally, the width of the leg is less than their length. Typical leg widths can range from about 2 nm to about 10 nm, particularly about 2 nm to about 5 nm.

In various aspects, quantum dot 110 can be water-soluble. In an aspect, the quantum dot 110 that is water soluble is hydrophilic and can be incorporated in water, toluene and other solvents whereby the quantum dot 110 can remain monodisperse. A hydrophilic quantum dot is dispersed in a liquid as opposed to other forms of quantum dot 110 which can take the form of a dry powder. In an instance, a dry powder form of quantum dot 110 can be incorporated into glass material 120 or a water-soluble quantum dot 110 that is suspended in solvent such as water or toluene can be incorporated into glass material 120. For purposes of a quantum dot 110 that is water soluble, the quantum dot is suspended in solvent. In an aspect, quantum dot 110 is a water-soluble semiconductor comprising: a base semiconductor material; and a shell semiconductor material surrounding the base material. Any of the forms, shapes, and sizes of quantum dot 110 can comprise the base semiconductor and shell semiconductor makeup.

In an aspect, the base material is an II-IV semiconductor or a III-V semiconductor. In another aspect, the base semiconductor material is a II-IV semiconductor. In yet another aspect, the base semiconductor material is a III-V semiconductor. Accordingly, in an aspect the base semiconductor material can be at least one of: MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, or HgTe. Furthermore, in an aspect, the base semiconductor material is at least one of: GaAs, InGaAs, InP, or InAs. In an instance, the quantum dot 110 can comprise just a core material. For instance a quantum dot 110 can be a CdSe core nanoparticle. However, where the quantum dot 110 comprises a shell layer, the shell semiconductor material can be a II-VI semiconductor or a III-V semiconductor. In another aspect, the shell semiconductor material is a II-VI semiconductor. Furthermore, the shell semiconductor material can be a III-V semiconductor. In another aspect, the shell semiconductor material is at least one of: MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, or HgTe. In yet another aspect, the shell semiconductor material is at least one of: GaAs, InGaAs, InP, or InAs. In an instance, the base semiconductor material is CdSe and the shell semiconductor material is a ZnS. Thus a quantum dot 110 that is a multi-leg luminescent nanomaterial can comprise a CdSe base epitaxially covered by a ZnS shell. In another instance, the base material can be a CdSe that is surrounded by a ZnS shell material. Coating a base material with a shell can improve the chemical and photo-stability of the quantum dot 110. The thickness of the base material and the shell material can also effect photoluminescence of the quantum dot 110.

In an aspect, the quantum dot 110 is capable of being excited by an excitation source over a broad bandwidth. The excitation of the quantum dot 110 occurs when an excitation source causes an electron to become excited and jump from a lower energy level to a higher energy level, leaving behind a hole at the location the electron previously occupied. The flow of the electron in one direction (e.g. pulling of the electron in a direction by a semiconductor), and flow of the electron in another direction (e.g. another semiconductor material pulling the electron in a direction) leads to an electron current. The energy levels of electrons in quantum dot 110 depends on its size wherein a smaller quantum dot 110 requires greater energy to excite electrons to another level.

In an aspect, by changing the size of quantum dot 110, the size change can tune the quantum dot 110 to absorb a particular wavelength of light. A glass material 130 that incorporates multiple sizes, shapes and forms of quantum dot 110 can absorb multiple excitation sources such as multiple wavelengths of light. In an aspect, the excitation source can be electromagnetic radiation of wavelength ranges from x-ray to ultraviolet to visible light to infrared waves to excite the quantum dot 110. In another aspect, the quantum dot 110 is capable of excitation from bombardment with a particle beam such as an electron beam. Accordingly, many forms, sizes, shapes, and types of quantum dot 110 can be incorporated or dispersed into glass material 130 to form quantum dot dispersed glass article 150 that exudes unique luminescent color properties.

In an aspect, glass material 130 is a structured material that can take a solid form (wherein the glass is amorphous) or a liquid form (sometimes called a glass transition state). Glass is fundamentally comprised of silica (SiO₂), however, typically other substances are added to glass to reduce the temperature in which glass can be transformed from one state (e.g. solid state) to another state (e.g. liquid state). For instance, the addition of sodium carbonate (Na₂CO₃) to silica can lower the temperature required to transform glass from state to state. While glass can contain many different ingredient to affect its characteristics such as melting point, a common aspect of glass is coloring. Glass may be colored in a variety of ways including adding charged ions to the glass material, adding colloidal nanoparticles, light scattering, color coating, or adding glass pigments such as iron oxides, manganese oxides, or other such compounds to glass. In an aspect, glass material 130 is colored, as described herein, by dispersing one or more quantum dot 110 within the glass material 130. The addition of quantum dot 110 to glass material 130 may be performed in connection with other traditional forms of coloring such as adding glass pigment compounds to the glass material 130 in addition to quantum dot 110.

Additionally, in an aspect, quantum dot 110 can be dispersed within glass material 130 homogenously or heterogeneously in that a variety of types (e.g. various shapes, sizes, forms, colors, etc.) of quantum dot 110 may be dispersed within glass material 120. Furthermore the dispersion of the quantum dot 110 may be more heavily concentrated in one area over another or evenly spread throughout the glass material 130 to bring about a desired luminescent color effect in the quantum dot dispersed glass article 150.

In an aspect, quantum dot 110 can be added glass material 130 at a point when the glass material 130 is a liquid or possess a viscous characteristic. The liquid glass material 130 will cool with the quantum dot 110 dispersed therein forming a solid amorphous glass state that comprises a quantum dot 110 dispersed throughout. In another aspect, glass material 130 that is a solid state may be coated with a quantum dot thin film layer in order to create an outer surface layer of quantum dot 110 that luminesces upon excitation. In yet another aspect, quantum dot 110 that is water-soluble or hydrophilic may be dispersed in a liquid medium such as water, toluene or other such solvent and the quantum dot dispersed liquid may be dispersed (e.g. via pouring) into glass cavities whereby upon excitation, the quantum dot dispersed liquid luminesces one or more colors within the respective glass cavities. Additionally, such cavities may be sealed subsequent to the dispersion of the quantum dot dispersed liquid within the respective cavities.

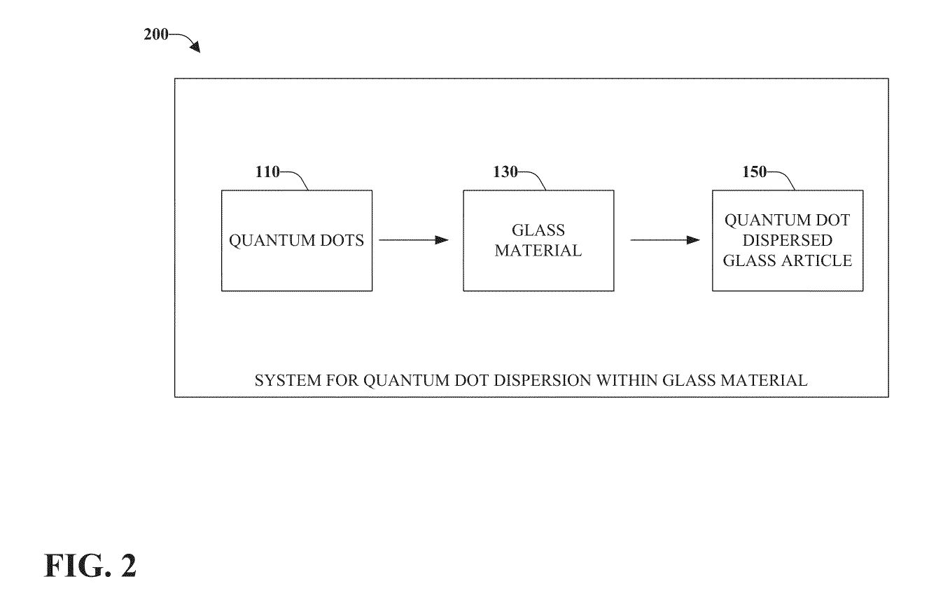

Turning now to FIG. 2, presented is a non-limiting embodiment of a system 200 for quantum dot dispersion within glass material in accordance with one or more implementations. In an aspect, quantum dot 110 is dispersed within the glass material 130 to form quantum dot dispersed glass article 150. In an aspect, the process may be performed in whereby quantum dot 110 of any type, shape, size, and form may be dispersed within glass material 130 to form quantum dot dispersed glass article 150. For instance, a mixture of quantum dot 110 such as teardrop quantum dots, arrow quantum dots, snowflake quantum dots, multi-leg luminescent nanoparticle quantum dots, multi-branched luminescent nanoparticle compound quantum dots, sphere quantum dots, luminescent tetrapod dot, tetrapod quantum dots, quantum dot rod, and quantum dot dendrimer or any combination thereof can be added to glass material 130 to form quantum dot dispersed glass article 150. A mixture of quantum dot 110 can elicit a color effect whereby many luminescent colors shine various colors simultaneously. Additionally, the quantum dot 110 can be of various forms such as quantum dots dissolved in water or toluene or quantum dots in powder form. Either form of quantum dot 110 may be added to glass material 130 either in combination or separately to form quantum dot dispersed glass article 150.

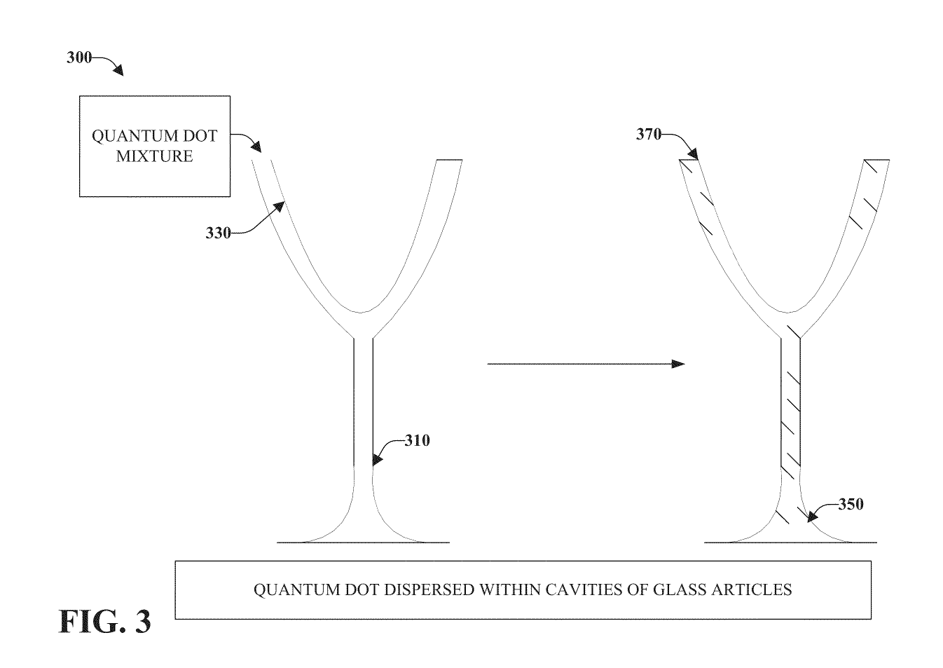

Turning now to FIG. 3, presented is a non-limiting embodiment of an exemplary quantum dot dispersed within cavities of glass articles. In an aspect, a quantum dot mixture 300 can be incorporated into crevices, cavities, openings, nooks, crannies, orifices within glass products, on the surface of glass products, or both within and on the surface of glass products. In an aspect, a liquid or powder quantum dot mixture 300 can be added into a glass cavity 330 such as a hollow of a body of glass 310. FIG. 3 illustrates a quantum dot mixture 300 such as a quantum dots dissolved in toluene pouring into the hollow opening of a martini glass body. The martini glass is comprised of glass, however possesses a hollow cavity within the glass enclosure. The quantum dot mixture 300 once poured into the hollow opening of the martini glass opening may be sealed with an enclosure 370 such as a glass enclosure (e.g. whereby the glass is melted together) thereby creating a martini glass with a quantum dot mixture 300 enclosed within a cavity of the martini glass body.

The resulting quantum dot dispersed within the cavity of glass articles, such as the luminescent martini glass 350 allows for a product with luminescent color properties. Thus when the martini glass is excited by an excitation source such as sun light or UV light, the glass will luminesce various colors in accordance with the quantum dot mixture within the hollow body of the glass. In an aspect, the quantum dot dispersed with cavities of glass articles can occur in any glass object such as sculptures, vases, table surfaces, windows, mobile device screens, windshields, and other such glass articles. Furthermore, merely by tilting the object or turning it in various directions or various degrees or adjusting the distance, angle, or intensity of the excitation source, the luminescence and color characteristics of the quantum dot dispersed glass article can change. This can provide a visual display for users of such glass articles.

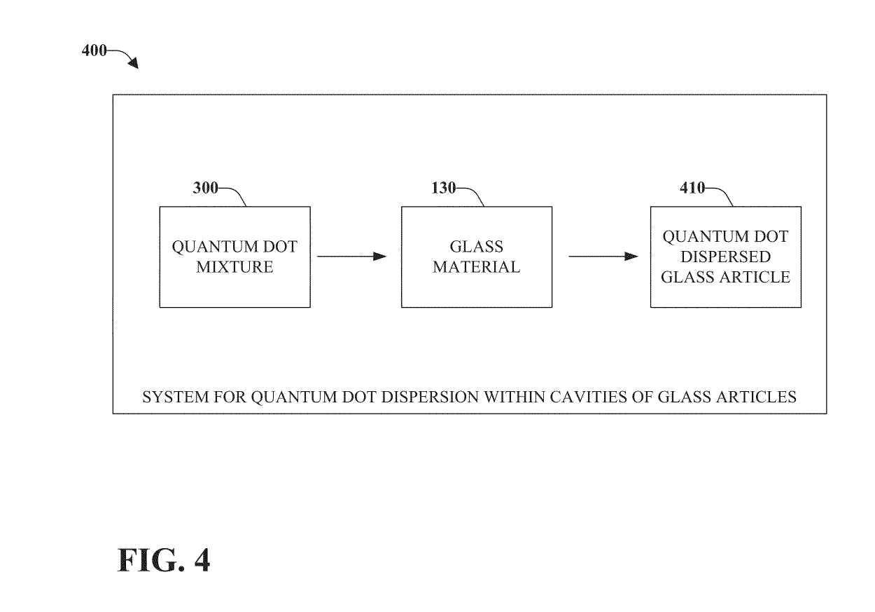

Turning now to FIG. 4 is a system 400 for quantum dot dispersion within cavities of glass articles. In an aspect quantum dot 110 or quantum dot mixture 300 can be added into the crevices, orifices, cavities, hollow openings, nooks, and crannies of glass material 130 and in some instances sealed within the respective cavities to form a quantum dot dispersed glass article 410, such as luminescent martini glass 350. A variety of other luminescent glass articles can be formed by this process and such articles may be adapted for manufacture in large scale to meet consumer demand and distribute on a commercial scale. The luminescent glass articles may be used in various artworks, sculptures, eyewear, drink sets, kitchenware, windows, table surfaces, and other such glass based products.

In other embodiments, quantum dot 110 can be dispersed within, coated on the surface or incorporated into other materials including, but not limited to, ink, ceramic, crystal, plastic, cement, wood, fiber, leather, fabric, paint, glass, chalk, or dye. In an aspect, quantum dot 110 can be incorporated into plastics by forming a quantum dot 110 in a dry, powder or aqueous forms by any method; providing a film of one or more plastics, wherein the film may be laminated, blown, cast, molded, extruded; and coating the quantum dot 110 on the film of plastic by various coating techniques, including, but not limited to, spin coating, dip coating, spray coating, ion beam coating, plasma coating, sputtering. In another aspect, a quantum dot 110 coating is formed directly on the film. In certain embodiments, the grain size of the coating is one that would qualify it as a luminescent quantum dot per definitions herein.

In another embodiment, quantum dot 110 is dispersed into paints, adhesives, creams, or inks The quantum dot 110 can be incorporated into the materials by concocting a formulation of paints, adhesives, creams, or inks; mixing quantum dot 110 with the paints, adhesives, creams, or inks; coating articles and products with such mixed formulation. Furthermore, in an aspect, functional groups or compounds can be added to the surface of quantum dot 110 to easily disperse and ensure homogeneity of the paints, adhesives, creams, or inks

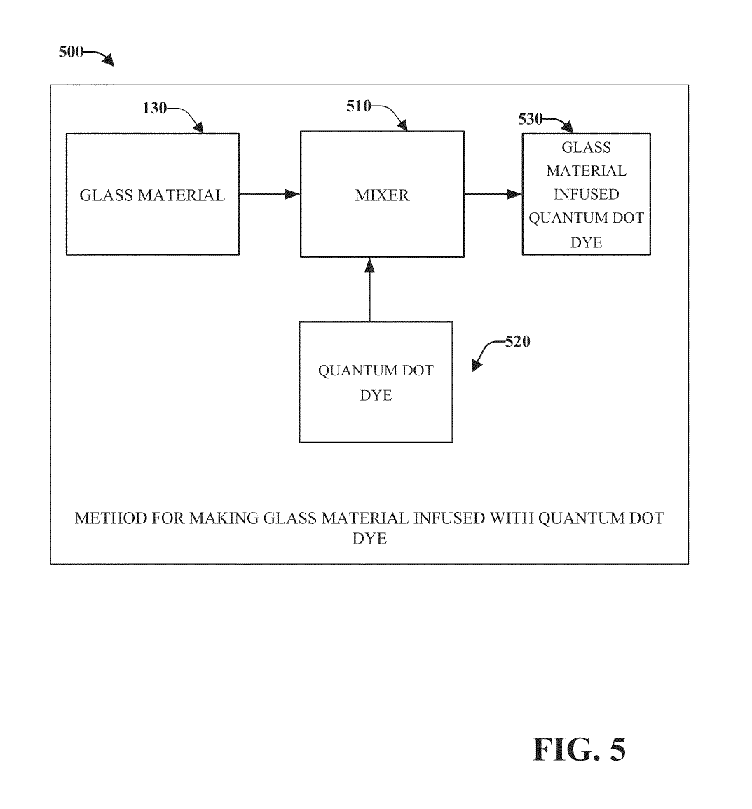

FIGS. 5-7 illustrates a methodology or flow diagram in accordance with certain aspects of this disclosure. While, for purposes of simplicity of explanation, the methodologies are shown and described as a series of acts, the disclosed subject matter is not limited by the order of acts, as some acts may occur in different orders and/or concurrently with other acts from that shown and described herein. For example, those skilled in the art will understand and appreciate that a methodology can alternatively be represented as a series of interrelated states or events, such as in a state diagram. Moreover, not all illustrated acts may be required to implement a methodology in accordance with the disclosed subject matter. Additionally, it is to be appreciated that the methodologies disclosed in this disclosure are capable of being stored on an article of manufacture to facilitate transporting and transferring such methodologies to computers or other computing devices.

In other embodiments, quantum dot 110 can be applied to rubber formulations, paper pulp (e.g. via processes such as mixing, processing, molding, couching, calendaring, etc.), leather, fibers, fabric (e.g. via processes such as impregnating, bonding, processing, applying functional groups, etc.). Furthermore, in an aspect, the quantum dot 110 can be excited with excitation sources once incorporated within the various listed materials in order to provide luminescent color properties and color changing properties in such materials.

Referring now to FIG. 5, presented is a flow diagram of an example application of system for quantum dot dispersion within glass material disclosed in this description in accordance with an embodiment. In an aspect, exemplary methodology 500 for making glass material infused with quantum dot dye is disclosed. A glass material 130 is added to a mixer 510. The mixer performs a mixing action whereby a suitable mixer known in the art is used, such as fluidized bed mixers, paddle mixers, rotary drum mixers, twin-worm mixers, particle mixer, and other such mixing apparatuses. Following the mixing, a quantum dot dye 520 of any number of concentrations may be dispersed within the mixer and mixed along with glass material 130. In an instance, the glass material 130 may be molten glass which can be mixed by a rotating mixing blade that moves horizontally thereby homogenizing the molten glass. The mixing of the glass material 130 with the quantum dot dye 520 may take into consideration the viscosity of the glass, flow rate of the glass, and temperature of the glass in order to protect the quantum dot dye 520 and facilitate proper dispersion of the quantum dot dye 520 within the glass material 130.

In an aspect, a flow nozzle can be used to allow the molten glass to flow into the mixer 510. The flow nozzle can comprise a heater that controls the temperature of the molten glass flowing through the flow nozzle. In another aspect, the flow nozzle can be adjusted to tighten or expand the inner diameter whereby the glass can flow through the nozzle in globular forms of a desired diameter. The glass material 130 mixed with the quantum dot dye 520 results in a glass material infused with quantum dot dye 530. In an aspect, quantum dot dye 630 are particles that have properties whereby it is: tunable over a range of wavelengths, a plurality of different quantum dot dye particles (at different wavelengths, size, shape, form, etc.) of different colors and intensities can be excited by a single excitation source of a single wavelength (e.g. monochromatic light source), and photostable.

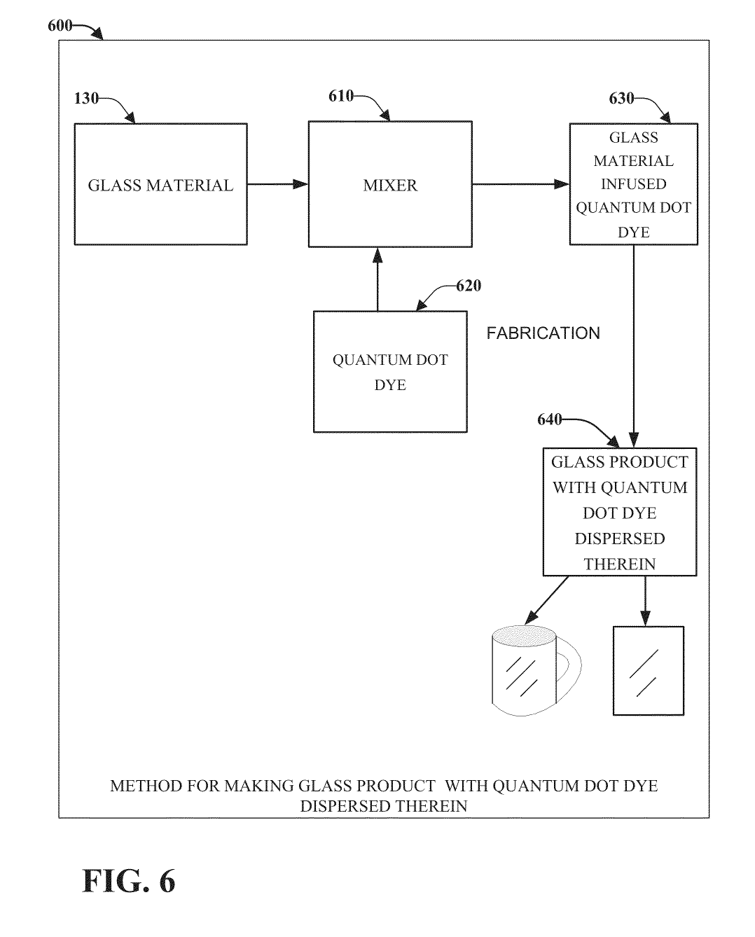

Referring now to FIG. 6, presented is a flow diagram of an example application of system for quantum dot dispersion within glass material disclosed in this description in accordance with an embodiment. In an aspect, exemplary methodology 600 for making glass material infused with quantum dot dye is disclosed. A glass material 130 is added to a mixer 610. The mixer performs a mixing action whereby a suitable mixer known in the art is used, such as fluidized bed mixers, paddle mixers, rotary drum mixers, twin-worm mixers, particle mixer, and other such mixing apparatuses. Following the mixing, a quantum dot dye 620 of any number of concentrations may be dispersed within the mixer and mixed along with glass material 130. In an instance, the glass material 130 may be molten glass which can be mixed by a rotating mixing blade that moves horizontally thereby homogenizing the molten glass. The mixing of the glass material 130 with the quantum dot dye 620 may take into consideration the viscosity of the glass, flow rate of the glass, and temperature of the glass in order to protect the quantum dot dye 620 and facilitate proper dispersion of the quantum dot dye 620 within the glass material 130.

In an aspect, a flow nozzle can be used to allow the molten glass to flow into the mixer 610. The flow nozzle can comprise a heater that controls the temperature of the molten glass flowing through the flow nozzle. In another aspect, the flow nozzle can be adjusted to tighten or expand the inner diameter whereby the glass can flow through the nozzle in globular forms of a desired diameter. The glass material 130 mixed with the quantum dot dye 620 results in a glass material infused with quantum dot dye 630. In an aspect, quantum dot dye 630 are particles that have properties whereby it is: tunable over a range of wavelengths, a plurality of different quantum dot dye particles (at different wavelengths, size, shape, form, etc.) of different colors and intensities can be excited by a single excitation source of a single wavelength (e.g. monochromatic light source), and photostable.

In an aspect, the glass material infused quantum dot dye can be shaped, manufactured, or processed into various quantum dot dispersed glass products, such as luminescent martini glasses, or luminescent window pains and other such glass product with quantum dot dye dispersed therein 640. The large scale manufacturing of such products can be accomplished by integrating any of the processes or methodologies disclosed herein with any glass product production processes known in the art.

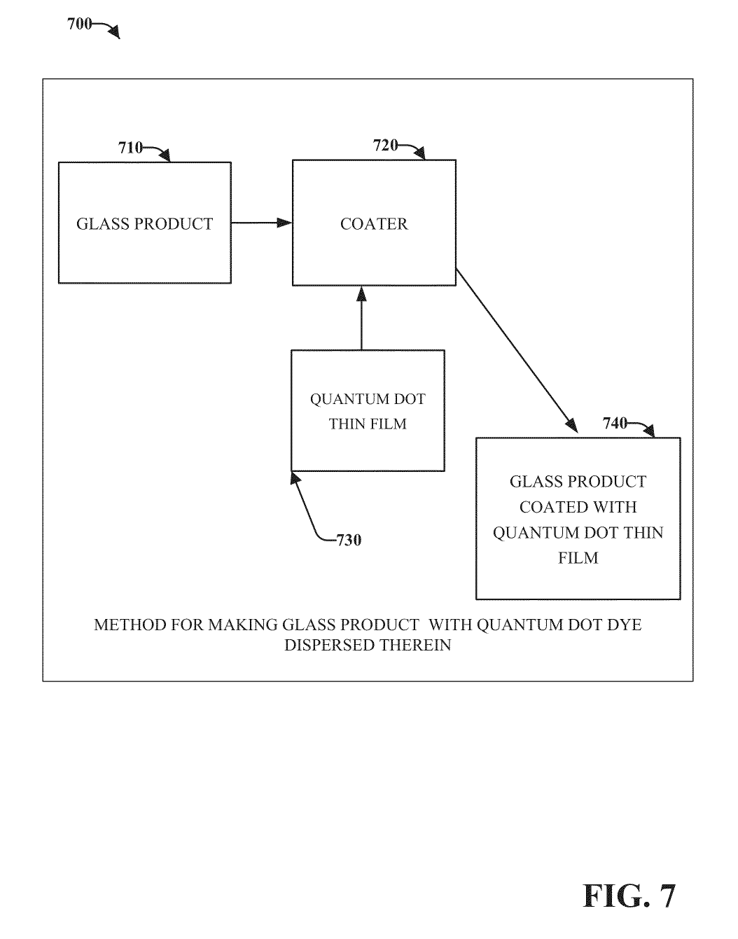

Referring now to FIG. 7, presented is a flow diagram of an example application of system for glass products with quantum dot thin films disclosed in this description in accordance with an embodiment. In an aspect, exemplary methodology 700 for making glass products coated with quantum dot thin film is disclosed. A glass product 710 and quantum dot thin film 730 is added to a coater 720. A glass product 710 are any products comprised of a solid or liquid glass material such as a martini glass, window, eye glass lenses, table surface, sculptures, mobile device screens, security glass, car windshields, armor glass, bullet proof glass, lighting glass products, glass components, decorative glass, safety and security glass, glass products for the home, energy efficient glass, and other such glass products for retail, commercial and other uses. A quantum dot thin film 730 is a layer of quantum dot material that can range between a nanomaterial in thickness to many micrometers in thickness.

The quantum dot thin film can be comprised of any type, shape, size and form of quantum dot including those quantum dots described herein. The coater 720 coats one or more glass product 710 with a quantum dot thin film 730. The coater applies the quantum dot thin film 730 to the surface of glass product 710. The coater can apply one more coats of varying thickness to the surface of glass product 710. The coater 720 can make use of any coating process known in the art including plating, chemical solution deposition, spin coating, chemical vapor coating, physical deposition, thermal evaporation, sputtering, pulsed laser deposition, and other such coating techniques. A quantum dot thin film coated glass product 740 is formed from the coating method and such method alone or in connection with other methods can be used to upscale commercial production of quantum dot thin film coated glass products 740. The respective products will luminesce various colors when excited by an excitation source. Furthermore, the quantum dot thin film coating 730 can comprise quantum dots of varying shapes, sizes, colors, forms, types, and wavelengths.

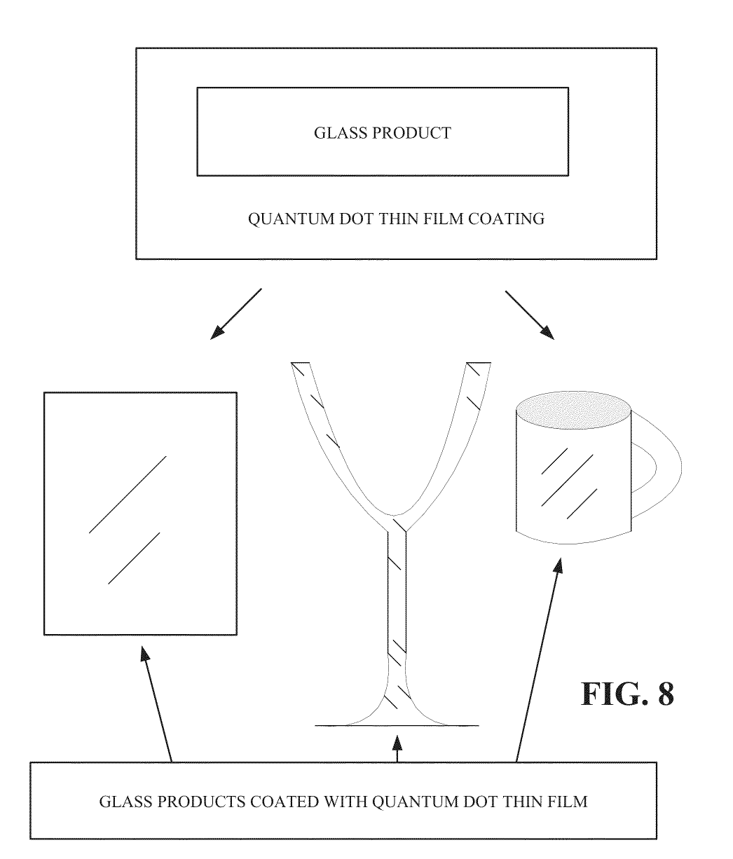

Turning now to FIG. 8, illustrated are examples of glass products coated with thin film quantum dots. Such glass products luminesce when excited by an excitation source such as the sun or ultraviolet light. Furthermore, when such products are tilted, turned, or manipulated, the luminescent color characteristics can change and turn different colors with various intensities. The respective quantum dot tin film coated glass products can be manufactured and upscaled by coating processes known in the art.

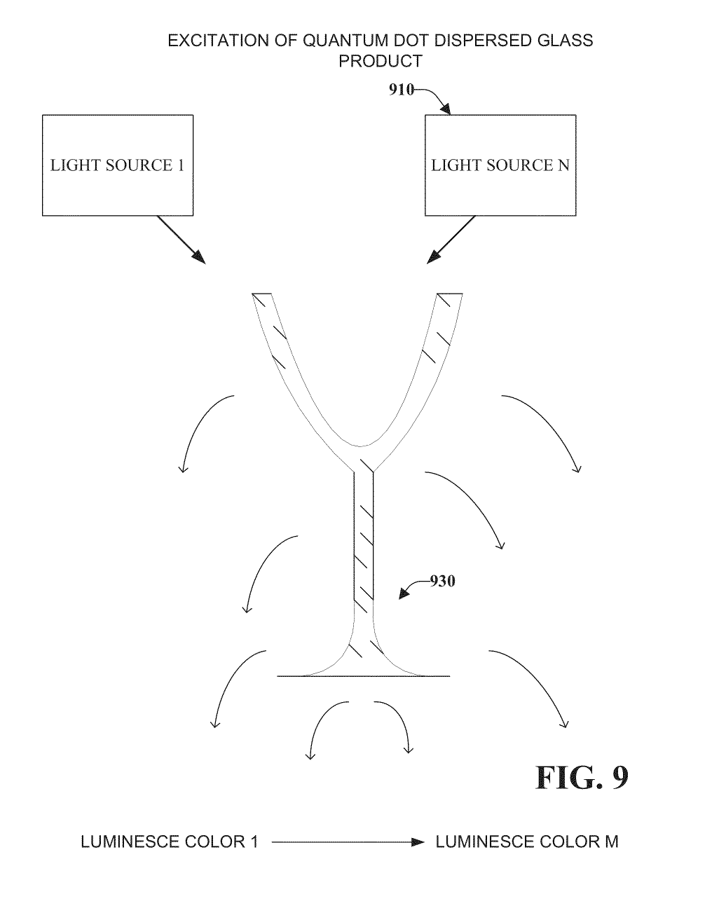

Turning now to FIG. 9, illustrated is an example of excitation of a quantum dot dispersed glass product or a quantum dot thin film coated glass product. The quantum dot dispersed or coated glass product 920 can be excited by N excitation source 910, wherein N is an integer. Thus an excitation source can be positioned to excite the glass product from any angle, side, degree, or view and effect the luminescence properties of the glass product by causing color changes or changes in luminescence intensity for instance. Accordingly, a quantum dispersed or coated glass product 930 can luminesce M colors, wherein M is an integer. Thus various colors can be exhibited in a single quantum dot dispersed or coated glass product 920. The number and variance of colors depend on the types, sizes, shapes, forms and other quantum dot qualities that are dispersed within or coated upon the quantum dot dispersed or coated glass product 930.

In view of the exemplary systems described above, methodologies that may be implemented in accordance with the described subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described in this disclosure. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described in this disclosure, it is to be understood that other similar embodiments can be used or modifications and additions can be made to the described embodiment(s) for performing the same or equivalent function of the corresponding embodiment(s) without deviating there from. Accordingly, the invention is not to be limited to any single embodiment, but rather can be construed in breadth, spirit and scope in accordance with the appended claims.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from any computer-readable device or storage media.

What is claimed is:

1. An article, comprising:
a glass material incorporating one or more quantum dots dispersed therein, wherein the one or more quantum dots luminesce upon excitation from an excitation source.

2. The article of claim 1, wherein the at least one quantum dots are of at least one of the following shapes: teardrop, arrow, snowflake, multi-leg luminescent nanoparticle, multi-branched luminescent nanoparticle compound, sphere, luminescent tetrapod dot, tetrapod, rod, or dendrimer.

3. The article of claim 1, wherein the at least one quantum dots have a longest diametric length greater than 1 nm and smaller than 999 nm.

4. The article of claim 1, wherein the at least one quantum dots are water-soluble.

5. The article of claim 1, wherein the at least one quantum dots comprise a water-soluble semiconductor comprising:
a base semiconductor material; and
a shell semiconductor material surrounding the base material.

6. The article of claim 5, wherein the base material is a II-IV semiconductor or a III-V semiconductor.

7. The article of claim 5, wherein the base semiconductor material is a II-IV semiconductor.

8. The article of claim 5, wherein the base semiconductor material is a III-V semiconductor.

9. The article of claim 6, wherein the base semiconductor material is at least one of: MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, or HgTe.

10. The article of claim 7, wherein the base semiconductor material is at least one of: GaAs, InGaAs, InP, or InAs.

11. The article of claim 5, wherein the shell semiconductor material is a II-VI semiconductor or a III-V semiconductor.

12. The article of claim 11, wherein the shell semiconductor material is a II-VI semiconductor.

13. The article of claim 11, wherein the shell semiconductor material is a III-V semiconductor.

14. The article of claim 12, wherein the shell semiconductor material is at least one of: MgS, MgSe, MgTe, CaS, CaSe, CaTe, SrS, SrSe, SrTe, BaS, BaSe, BaTe, ZnS, ZnSe, ZnTe, CdS, CdSe, CdTe, HgS, HgSe, or HgTe.

15. The article of claim 13, wherein the shell semiconductor material is at least one of: GaAs, InGaAs, InP, or InAs.

16. The article of claim 5, wherein the base semiconductor material is CdSe and the shell semiconductor material is a ZnS.

17. The article of claim 1, wherein the at least one quantum dots are emit at one or more wavelengths in the Ultraviolet, visible, or infrared spectrum.

18. The article of claim 1, wherein the nanocrystal is any one or more of: dispersed within the glass material, dispersed within a cavity of the glass material, or coated on the surface of the glass material.

19. A method, comprising:
dispersing one or more quantum dots into a glass material; and
exciting the one or more quantum dots using an excitation source.

20. The method of claim 19, wherein the one or more quantum dots comprise water-soluble semiconductor comprising:
a base semiconductor material; and
a shell semiconductor material surrounding the base material.
